(19) United States
(12) Patent Application Publication
(10) Pub. No.: US 2019/0219848 A1
(43) Pub. Date: Jul. 18, 2019

(54) LIQUID CRYSTAL DEVICE AND ELECTRONIC APPARATUS

(71) Applicant: SEIKO EPSON CORPORATION, Tokyo (JP)

(72) Inventor: Toru AOKI, Shiojiri-shi (JP)

(73) Assignee: SEIKO EPSON CORPORATION, Tokyo (JP)

(21) Appl. No.: 16/248,030

(22) Filed: Jan. 15, 2019

(30) Foreign Application Priority Data
Jan. 15, 2018 (JP) 2018-004011

(51) Int. Cl. G02F 1/137; G02F 1/13363; G09G 3/36

(52) U.S. Cl. CPC G02F 1/137; G02F 1/13363; G09G 3/3607; G02F 1/133734; G02F 2203/64; G02F 2203/30; G02F 2001/13712; G02F 2203/01

(57) ABSTRACT

A transmissive-type liquid crystal device of a normally black mode, an image processing circuit configured to output an applied voltage to be applied to a liquid crystal element, and a phase difference compensation element configured to cancel a phase difference occurring inside of the liquid crystal element. The phase difference compensation element is disposed such that, in relative transmittance-voltage characteristics representing a relationship between an applied voltage and an intensity of light emitted from the liquid crystal element, the intensity of the light emitted from the liquid crystal element is minimized with an applied voltage corresponding to a point belonging to an area Z having a large change in inclination of a tangent line disposed between areas X and Y exhibiting a small change in inclination of a tangent line touching each of points on a light intensity-voltage characteristic corresponding to each of applied voltages at every predefined voltage interval.

### BACKGROUND

### 1. Technical Field

The invention relates to a liquid crystal device in which an optical compensation element is provided in a liquid crystal panel, and an electronic apparatus.

### 2. Related Art

A liquid crystal panel includes a liquid crystal layer between a plurality of pixel electrodes formed on a first substrate and a common electrode formed on a second substrate. The liquid crystal panel configures a liquid crystal device together with an optical compensation element disposed on at least one of the opposite side to the second substrate with respect to the first substrate and the opposite side to the first substrate with respect to the second substrate. In such a liquid crystal device, a voltage corresponding to a grayscale level of each of the pixels is applied between the pixel electrode and the common electrode, then an alignment state of the liquid crystal molecules is defined for each pixel in the liquid crystal layer, and in this state the transmittance or reflectance is controlled. Accordingly, among the electric fields acting on the liquid crystal molecules, the electric field (vertical electric field) alone, which is in the perpendicular direction (vertical direction) with respect to the first substrate or the second substrate between the pixel electrode and the common electrode, contributes to the display control.

However, a defective alignment of the liquid crystal (reverse tilt domain) occurs due to an influence of a lateral electric field generated between pixel electrodes adjacent to each other when the pixel pitch is narrowed to achieve a downsizing and a high definition, which may readily cause display defects. Under such a circumstance, a technology has been proposed, when there is a large difference between the voltages applied to pixel electrodes adjacent to each other, in which a correction for increasing lower voltage in an applied voltage to a predefined voltage is performed to mitigate an influence of the reverse tilt domain (refer to JP-A-2013-152483).

Unfortunately, the technology described in JP-A-2013-152483, in which the lower voltage in the applied voltage is corrected to higher voltage, readily causes the image to be blurred when the influence of the reverse tilt domain is mitigated by the above correction alone. On the contrary, when the correction is reduced in order to suppress the occurrence of the blurring, the influence of the reverse tilt domain becomes obvious.

### SUMMARY

In view of the above, the object of the invention is to provide a liquid crystal device capable of suppressing the influence of the reverse tilt domain while suppressing the occurrence of the blurring, and an electronic apparatus.

To achieve the object above, one aspect of a liquid crystal device according to the invention includes a liquid crystal element, an image processing circuit configured to output an applied voltage to be applied to the liquid crystal element, and a phase difference compensation element disposed in the liquid crystal element. Provided that a light intensity-voltage characteristic is defined by a relationship between the applied voltage and an intensity of light emitted from the liquid crystal element, the phase difference compensation element is configured to minimize or maximize the intensity of the light emitted from the liquid crystal element with an applied voltage corresponding to a point belonging to an area having a large change in inclination of a tangent line located between two areas exhibiting a small change in inclination of a tangent line touching each of points on the light intensity-voltage characteristic.

In the invention, a lowest applied voltage corresponding to a lowest grayscale level in normally black or a highest grayscale level in normally white is set, in the light intensity-voltage characteristic, in an area having a large change in inclination of the tangent line located between two areas exhibiting a small change in inclination of the tangent line touching each of points on the light intensity-voltage characteristic corresponding to each of applied voltages at every predefined voltage interval. This prevents an influence of a lateral electric field from the adjacent liquid crystal element due to a vertical electric field applied to the liquid crystal element even when the applied voltage is set at the lowest applied voltage. Thus, even when there is a difference in the applied voltages of the adjacent liquid crystal elements, unlike the case where a configuration for correcting the applied voltage alone suppresses the influence of the reverse tilt domain, the occurrence of the blurring is suppressed while suppressing the influence of the reverse tilt domain. The optical compensation element performs an optical compensation such that the intensity of light emitted when the applied voltage is set at the lowest applied voltage is the minimum value or the maximum value, enabling the grayscale display to be properly performed.

In the invention, an aspect may be employed in which the liquid crystal element is set in a normally black mode, and a point belonging to an area having a large inclination of the tangent line corresponds to a lowest grayscale level among voltages applied to the liquid crystal element. In the case of a normally black mode, the influence of the reverse tilt domain is liable to be more apparent than in the case of a normally white, allowing the invention to be applied in a remarkable and effective manner.

In the invention, an aspect may be employed in which an applied voltage corresponding to the lowest grayscale level is higher than 0 V and a light intensity when the applied voltage is set at 0 V is higher than a light intensity when the applied voltage is set at the applied voltage corresponding to the lowest grayscale level.

In the invention, an aspect may be employed in which provided that a first threshold voltage is defined as a voltage at which a relative transmittance of the liquid crystal element becomes 10%, a second threshold voltage is defined as a voltage at which a relative transmittance of the liquid crystal element becomes 90%, and a highest applied voltage is defined as the applied voltage at which a highest grayscale level is achieved, a voltage difference between a lowest applied voltage and the first threshold voltage is less than a voltage difference between the highest applied voltage and the second threshold voltage.

In the invention, an aspect may be employed in which the liquid crystal element includes a liquid crystal layer between a pixel electrode formed on a first substrate and a common electrode formed on a second substrate. The first substrate is provided with a first alignment film to cover the pixel electrode and the second substrate is provided with a second alignment film to cover the common electrode, the first alignment film and the second alignment film each include a columnar structure layer in which columnar bodies are obliquely formed with respect to both the pixel electrode and the common electrode, and liquid crystal molecules used in the liquid crystal element have negative dielectric anisotropy, the liquid crystal molecules being aligned to have a pretilt inclined with respect to both the first substrate and the second substrate.

In the invention, an aspect may be employed in which a lowest applied voltage is a voltage that causes the liquid crystal molecules to be aligned at an angle corresponding to a pretilt angle.

In the invention, an aspect may be employed in which the image processing circuit is configured to correct an applied voltage applied to either one of the liquid crystal element and an adjacent liquid crystal element adjacent to the liquid crystal element such that a potential difference of applied voltages applied to the liquid crystal element and to the adjacent liquid crystal element adjacent to the liquid crystal element falls within a predefined range. According to the aspect above, even when a difference in the applied voltages is generated between pixel electrodes adjacent to each other, the influence of the reverse tilt domain is suppressed. The image may be blurred when the influence of the reverse tilt domain is suppressed by a correction of the applied voltage alone, while since this is combined with a configuration in which the lowest applied voltage is set at a voltage exceeding 0 V, the correction of the applied voltage is minimized. This suppresses the image from being blurred even when the influence of the reverse tilt domain is suppressed.

The liquid crystal device according to the invention may be used for electronic apparatuses such as mobile phones, mobile computers, and projection-type display apparatuses. Among these electronic apparatuses, the projection-type display apparatuses include a light source for supplying light to the liquid crystal device and a projection optical system for projecting light modulated by the liquid crystal device.

### BRIEF DESCRIPTION OF THE DRAWINGS

The invention will be described with reference to the accompanying drawings, wherein like numbers reference like elements.

FIG. 1 is a plan view illustrating one aspect of a liquid crystal device according to Exemplary Embodiment 1 of the invention.

FIG. 2 is an H-H′ cross-sectional view of the liquid crystal device illustrated in FIG. 1.

FIG. 3 is an explanatory diagram illustrating liquid crystal molecules and the like used in the liquid crystal device illustrated in FIG. 1.

FIG. 4 is a block diagram illustrating an electrical configuration of a liquid crystal device according to Exemplary Embodiment 1 of the invention.

FIG. 5 is a block diagram illustrating an electrical configuration of the pixel illustrated in FIG. 4.

FIG. 6 is an explanatory diagram illustrating a light intensity-applied voltage characteristic of the liquid crystal device illustrated in FIG. 1.

FIG. 7 is an enlarged explanatory diagram illustrating the vicinity of the applied voltage of 0 V in the transmittance-applied voltage characteristic illustrated in FIG. 6.

FIG. 8 is an explanatory diagram illustrating a grayscale voltage and the like in the liquid crystal device illustrated in FIG. 1.

FIG. 9 is an explanatory diagram illustrating an image processing circuit (image processing device) of a light modulation apparatus according to Exemplary Embodiment 2 of the invention.

FIGS. 10A to 10C are explanatory diagrams illustrating a correction of an applied voltage performed by the image processing circuit illustrated in FIG. 9.

FIG. 11 is an explanatory diagram illustrating a detection of a boundary by the image processing circuit illustrated in FIG. 9.

FIG. 12 is an explanatory diagram illustrating a grayscale voltage and the like of a liquid crystal device according to Exemplary Embodiment 3 of the invention.

FIG. 13 is a schematic configuration diagram illustrating a projection-type display apparatus (electronic apparatus) employing a liquid crystal device to which the invention is applied.

### DESCRIPTION OF EXEMPLARY EMBODIMENTS

Exemplary embodiments of the invention will be described with reference to the drawings. Note that in the drawings referred to in the description below, to illustrate each layer or each member at a recognizable size, each layer or each member is illustrated in a different scale.

### Exemplary Embodiment 1

### Configuration of Liquid Crystal Device

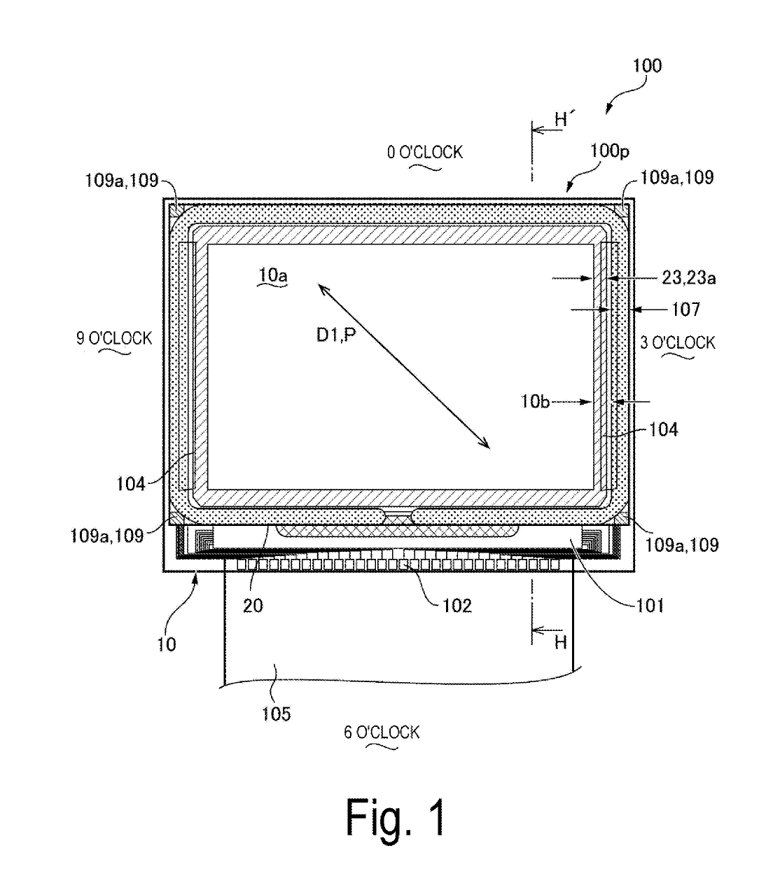

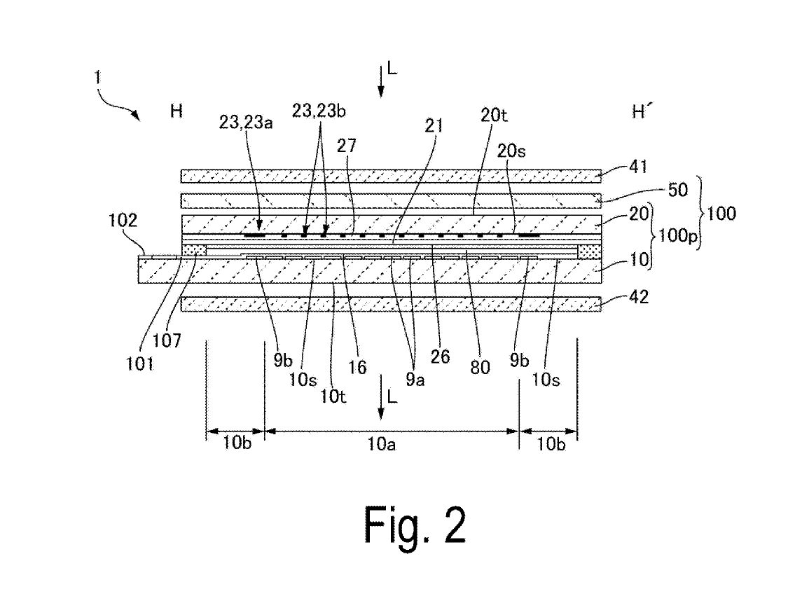

FIG. 1 is a plan view illustrating one aspect of a liquid crystal device 100 according to Exemplary Embodiment 1 of the invention. FIG. 1 illustrates a state where the liquid crystal device 100 is viewed from the side of a second substrate 20. FIG. 2 is an H-H′ cross-sectional view of the liquid crystal device 100 illustrated in FIG. 1. Note that, in FIG. 1, a liquid crystal panel 100p alone is illustrated while omitting the illustration of an optical compensation element 50 illustrated in FIG. 2.

As illustrated in FIG. 1 and FIG. 2, the liquid crystal device 100 includes the liquid crystal panel 100p in which a first substrate 10 having light translucency and the second substrate 20 having light translucency are bonded together with a sealing material 107 creating a predefined gap in between, and the optical compensation element 50. The optical compensation element 50, which also serves as a phase difference compensation element, is disposed on at least one of the opposite side to the second substrate 20 with respect to the first substrate 10 and the opposite side to the first substrate 10 with respect to the second substrate 20. In Exemplary Embodiment 1, the optical compensation element 50 is disposed to face the second substrate 20 on the opposite side to the first substrate 10. The sealing material 107 is provided in a frame-like shape in conformance with the outer edge of the second substrate 20. A liquid crystal layer 80 is disposed in an area surrounded by the sealing material 107 between the first substrate 10 and the second substrate 20. Note that the optical compensation element 50 may also be provided within the liquid crystal panel 100p.

When the liquid crystal device 100 thus configured is used for an optical modulator 1, a first polarization element 41 is disposed, closer to the second substrate 20, on the opposite side to the liquid crystal panel 100p with respect to the optical compensation element 50, while a second polarization element 42 is disposed closer to the first substrate 10. The first polarization element 41 and the second polarization element 42 are disposed in crossed Nicols such that their polarization axes are orthogonal to each other.

Both the first substrate 10 and the second substrate 20 have a quadrangle shape, and in a substantially central portion of the liquid crystal device 100, a display area 10a is provided as a rectangular area having a longer dimension in the direction from 3 o'clock toward 9 o'clock and a shorter dimension in the direction from 0 o'clock toward 6 o'clock. In accordance with such a shape, the sealing material 107 is also provided in a substantially rectangular shape, and a peripheral area 10b having a rectangular frame-like shape is provided between the inner peripheral edge of the sealing material 107 and the outer peripheral edge of the display area 10a.

The substrate body of the first substrate 10 is made of quartz, glass, or the like. On the side of the surface (the one surface 10s) of the first substrate 10 closer to the second substrate 20 and outside of the display area 10a, a data line drive circuit and a plurality of terminals 102 are formed along one of the sides of the first substrate 10, and a scan line driving circuit 104 is formed along another one of the sides adjacent to the one side. A flexible wiring substrate 105 is connected to the terminal 102. A variety of potentials and a variety of signals are input to the first substrate 10 via the flexible wiring substrate 105.

In the display area 10a on the side of the one surface 10s of the first substrate 10 are formed in a matrix pattern, a plurality of pixel electrodes 9a having light translucency and being formed of Indium Tin Oxide (ITO) film or the like and pixel switching elements (not illustrated) each of which is electrically connected to each of the plurality of pixel electrodes 9a. A first alignment film 16 is formed on the second substrate 20 side with respect to the pixel electrodes 9a. The pixel electrodes 9a are covered with the first alignment film 16.

The substrate body of the second substrate 20 is made of quartz, glass, or the like. On the side of the surface (the one surface 20s) of the second substrate 20 closer to the first substrate 10 is formed a common electrode 21 having light translucency and being formed of an ITO film or the like. A second alignment film 26 is formed on the first substrate 10 side with respect to the common electrode 21. Accordingly, the common electrode 21 is covered with the second alignment film 26. The common electrode 21 is formed on substantially the entire surface of the second substrate 20. On the opposite side to the first substrate 10 with respect to the common electrode 21 are formed a light shielding layer 23 having light shielding properties and being formed of a metal or a metal compound, and a protective layer 27 having light translucency. The light shielding layer 23 is formed, for example, as a partition 23a in a frame-like shape in conformance with the outer peripheral edge of the display area 10a. The light shielding layer 23 may also be formed as a black matrix 23b in an area overlapping in a plan view with an area located between pixel electrodes 9a adjacent to each other. In Exemplary Embodiment 1, in an area overlapping in a plan view with the partition 23a within the peripheral area 10b of the first substrate 10 are formed dummy pixel electrodes 9b formed concurrently with the pixel electrodes 9a.

In each of the areas overlapping with the corner portions of the second substrate 20 outside of the sealing material 107 on the first substrate 10 is formed an inter-substrate conduction electrode 109 for electrically connecting the first substrate 10 to the second substrate 20. On the inter-substrate conduction electrode 109 is disposed an inter-substrate conduction material 109a containing conductive particles. The common electrode 21 of the second substrate 20 is electrically connected to the first substrate 10 side via the inter-substrate conduction material 109a and the inter-substrate conduction electrode 109. Thus, a common potential is applied to the common electrode 21 from the first substrate 10 side.

The liquid crystal device 100 of Exemplary Embodiment 1 is configured as a transmissive-type liquid crystal device. The liquid crystal device 100 thus configured displays an image in such a manner that light incident from one substrate side of the first substrate 10 and the second substrate 20 is modulated while transmitting through the other substrate side to be emitted. In Exemplary Embodiment 1, the light incident from the second substrate 20 side, as indicated by the arrow L, is modulated at each pixel by the liquid crystal layer 80 while transmitting through the first substrate 10 to be emitted, by which an image is displayed.

Configuration of Liquid Crystal Layer 80

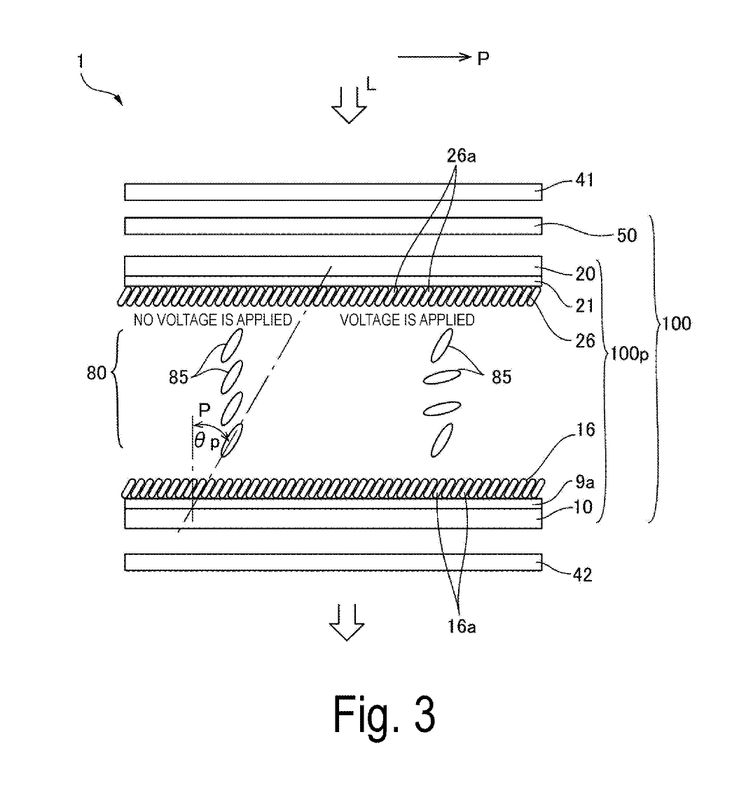

FIG. 3 is an explanatory diagram illustrating liquid crystal molecules 85 and the like used in the liquid crystal device 100 illustrated in FIG. 1. As illustrated in FIG. 3, the first alignment film 16 and the second alignment film 26 in the liquid crystal panel 100p are each an inorganic alignment layer formed of an obliquely deposited film of, for example, SiOₓ (x≤2), TiO₂, MgO, or Al₂O₃. Accordingly, the first alignment film 16 and the second alignment film 26 each include a columnar structure layer in which respective columnar bodies 16a or 26a, each named a column, are obliquely formed with respect to both the first substrate 10 and the second substrate 20. Thus, the first alignment film 16 and the second alignment film 26 cause the liquid crystal molecules 85 having negative dielectric anisotropy used for the liquid crystal layer 80 to be pretilted in a manner aligned with an oblique inclination with respect to the first substrate 10 and the second substrate 20. Herein, a pretilt angle θp refers to an angle defined between a direction orthogonal to the first substrate 10 and the second substrate 20 and the major axis (alignment direction) of the liquid crystal molecules 85 in a state where no voltage is being applied between the pixel electrodes 9a and the common electrode 21. In this way, the liquid crystal device 100 is configured as a liquid crystal device of a Vertical Alignment (VA) mode. In the liquid crystal device 100 thus configured, upon a voltage being applied between the pixel electrode 9a and the common electrode 21, the liquid crystal molecules 85 are displaced to minimize the tilt angle with respect to the first substrate 10 and the second substrate 20. The direction of such a displacement corresponds to a so-called clear vision direction. In Exemplary Embodiment 1, as illustrated in FIG. 1, the alignment direction P (clear view direction) of the liquid crystal molecules 85 is a direction in a plan view from 4:30 o'clock toward 10:30 o'clock.

Electrical Configuration of Liquid Crystal Device 100 and the Like

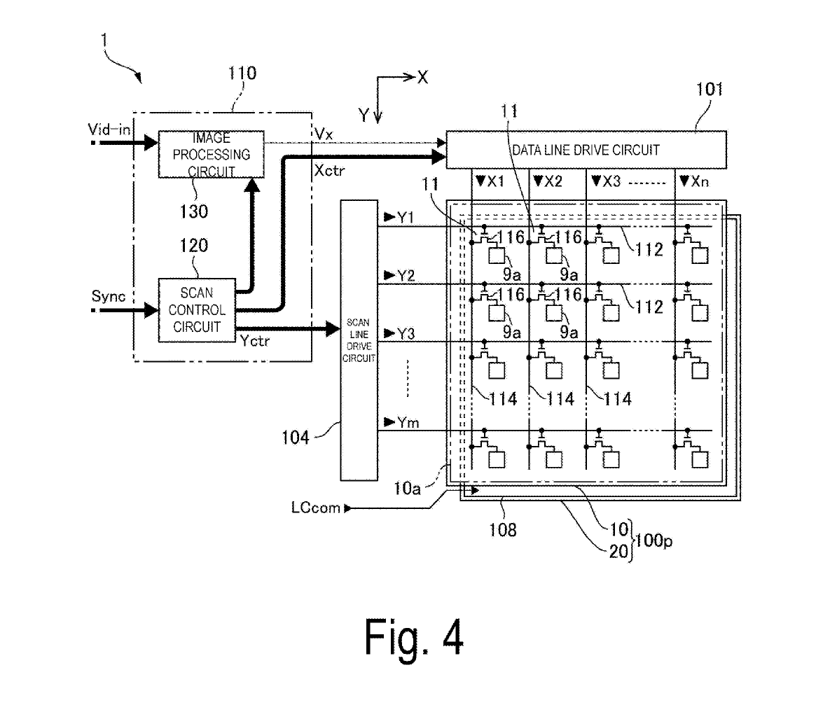

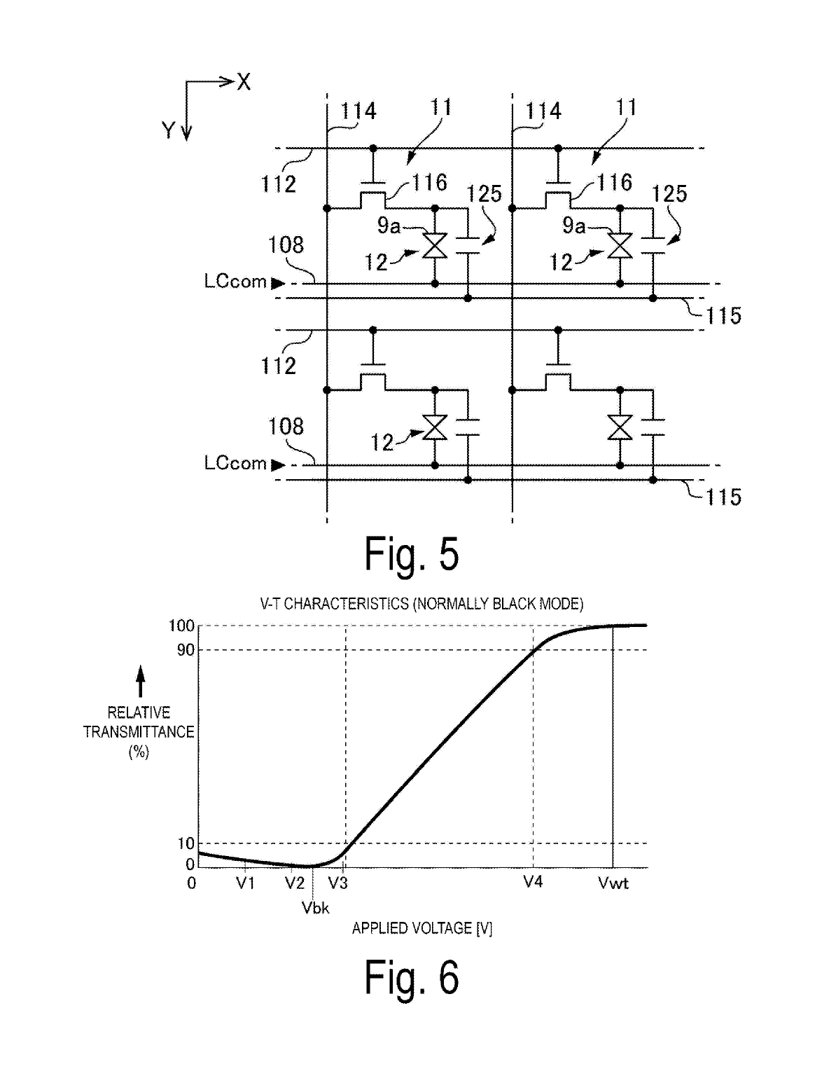

FIG. 4 is a block diagram illustrating an electrical configuration of the liquid crystal device 100 according to Exemplary Embodiment 1 of the invention. FIG. 5 is a block diagram illustrating an electrical configuration of the pixel illustrated in FIG. 4.

As illustrated in FIG. 4, the optical modulator 1 including the liquid crystal device 100 of Exemplary Embodiment 1 includes a control circuit 110 and the liquid crystal panel 100p, and in Exemplary Embodiment 1, the scan line driving circuit 104 and a data line drive circuit 101 are integrally formed in the liquid crystal panel 100p.

In the control circuit 110, an image signal Vid-in is supplied from a host device in synchronization with a synchronization signal Sync. The image signal Vid-in is digital data each for designating a grayscale level of each pixel in the liquid crystal panel 100p. The image signal Vid-in is supplied in a scanning order according to a vertical scan signal, a horizontal scan signal, and a dot clock signal included in the synchronization signal Sync. The image signal Vid-in designates the grayscale level, while the image signal Vid-in is to designate an applied voltage because the applied voltage to be applied between the pixel electrode 9a and the common electrode 21 illustrated in FIG. 3 is determined in accordance with the grayscale level. The control circuit 110 is configured by a scan control circuit 120 and an image processing circuit 130, where the scan control circuit 120 generates a variety of control signals to control each unit in synchronization with the synchronization signal Sync. The image processing circuit 130 processes an image signal Vid-in encoded in digital to output an analog data signal Vx corresponding to the grayscale level designated by the image signal Vid-in encoded in digital in such a manner that the applied voltage applied between the pixel electrode 9a and the common electrode 21 become a voltage corresponding to the grayscale level designated by the image signal Vid-in.

In the liquid crystal panel 100p, on the surface of the first substrate 10 facing the second substrate 20, a plurality of m rows of scan lines 112 are provided along the X (horizontal) direction, while a plurality of n columns of data lines 114 are provided along the Y (vertical) direction. The scan lines 112 and the data lines 114 are provided to be electrically insulated to each other. In Exemplary Embodiment 1, in order to distinguish the scan lines 112, there are cases where the rows are labeled with 1, 2, 3, . . . , (m−1), and m-th in the order from the top of the drawing. Similarly, in order to distinguish the data lines 114, there are cases where the columns are labeled with 1, 2, 3, . . . , (n−1), and n-th in the order from the left of the drawing.

In the first substrate 10, a pair of an n-channel TFT 116 (pixel switching element) and the pixel electrode 9a is provided corresponding to each of the intersections of the scan lines 112 and the data lines 114. The gate electrode of the TFT 116 is connected to the scan line 112, the source electrode is connected to the data line 114, and the drain electrode is connected to the pixel electrode 9a. A common potential LCcom is applied to the common electrode 21 of the second substrate 20 via a common potential line 108.

As illustrated in FIG. 5, a plurality of pixels 11 is formed corresponding to the intersections of the scan lines 112 and the data lines 114. In each of the plurality of pixels, a liquid crystal element 12 is provided in which the liquid crystal layer 80 is disposed between the pixel electrode 9a and the common electrode 21. Although not illustrated in FIG. 4, the liquid crystal panel 100p is provided with holding capacitors 125 in parallel with the liquid crystal elements 12. One end of the holding capacitor 125 is connected to the pixel electrode 9a, while the other end is commonly connected to a capacitor line 115. The capacitor line 115 is connected to the common potential line 108, to which the common potential LCcom is applied.

The scan line 112 becomes H level based on the control signal Yctr, then the TFT 116, the gate electrode of which is connected to the scan line 112, is turned on and the pixel electrode 9a is connected to the data line 114. For this reason, when the scan line 112 is at the H level and the data line drive circuit 101 supplies the data signal Vx being supplied from the image processing circuit 130 to the data line 114 based on a control signal Xctr, the data signal Vx is provided to the pixel electrode 9a via the TFT 116 that has been turned on. The scan line 112 falls to L level, then the TFT 116 is turned off, and the voltage applied to the pixel electrode 9a is retained by the capacitance of the liquid crystal element 12 and an auxiliary capacitor 125.

In the liquid crystal element 12, the molecular alignment state of the liquid crystal molecules 85 varies in accordance with the electric field generated by the pixel electrode 9a and the common electrode 21. This allows the liquid crystal element 12 of a transmissive-type to have a transmittance in accordance with the applied/holding voltage.

In the liquid crystal panel 100p, the liquid crystal element 12 corresponds to the pixel 11 because the transmittance varies for each of the liquid crystal elements 12. Then, the array area of the pixels 11 corresponds to the display area 10a. Note that, in Exemplary Embodiment 1, the liquid crystal layer 80 is of a VA type and is set in the normally black mode in which black displays when no voltage is applied.

Light intensity-Applied Voltage Characteristic of Liquid Crystal Device 100

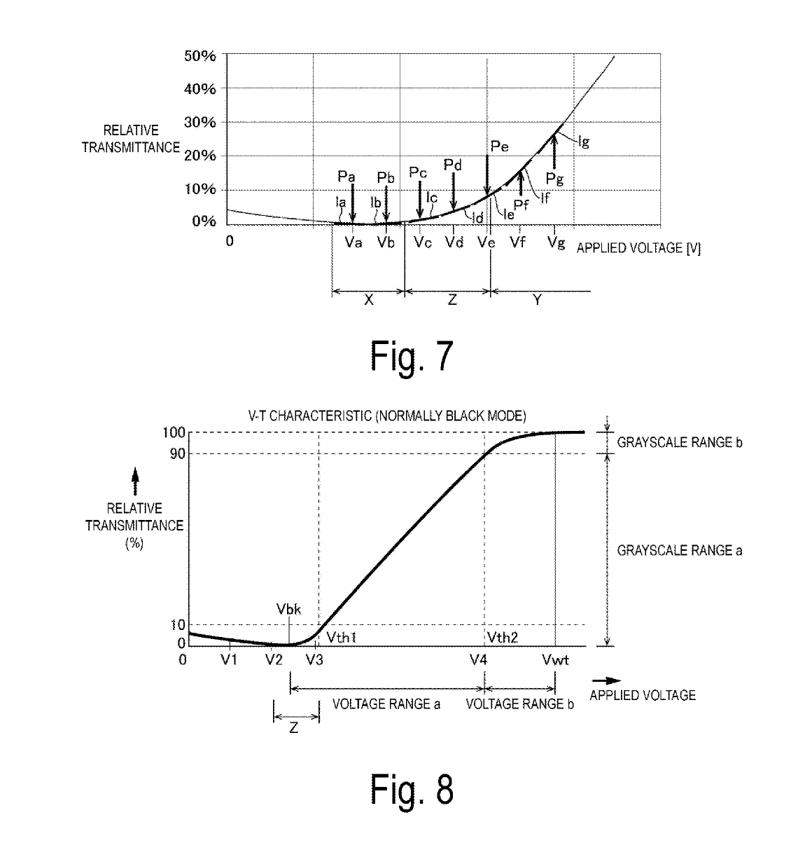

FIG. 6 is an explanatory diagram illustrating a light intensity-applied voltage characteristic of the liquid crystal device 100 illustrated in FIG. 1. FIG. 7 is an enlarged explanatory diagram illustrating the vicinity of the applied voltage of 0 V in the transmittance-applied voltage characteristic illustrated in FIG. 6.

In Exemplary Embodiment 1, the liquid crystal panel 100p is of a transmissive-type and is set in a normally black mode. For this reason, the relationship between the voltage applied to the liquid crystal element 12 (the voltage difference between the pixel electrode 9a and the common electrode 21) and the intensity of the light emitted from the liquid crystal panel 100p is represented by the V-T characteristics (relative transmittance-voltage characteristics) illustrated in FIG. 6 and FIG. 7. As recognizable from FIG. 6 and FIG. 7, in order to cause the liquid crystal element 12 to have a transmittance in accordance with a grayscale level designated by the image signal Vid-in, a voltage corresponding to the grayscale level is to be applied to the liquid crystal element 12.

In the invention, a phase difference compensation element 50 is disposed to achieve the grayscale level (lowest grayscale level) for displaying the darkest black at an applied voltage Vbk that is higher than 0 V. In FIG. 6, an applied voltage Vwt is an applied voltage corresponding to a grayscale level (highest grayscale level) for displaying the brightest white.

Then, in the invention, a configuration is given such that the applied voltage Vbk, the applied voltage Vwt, and applied voltages in between are applied from the image processing circuit 130 to the liquid crystal element 12 in correspondence with the lowest grayscale level, the highest grayscale level, and each of the intermediate grayscale levels in between, respectively.

Accordingly, an applied voltage ranging from 0 V to less than Vbk is a non-used applied voltage in a normal display. FIG. 6 illustrates the V-T characteristics additionally including the case where the non-used applied voltage range is temporarily applied. As illustrated in FIG. 6, as the applied voltage increases from 0 V to the voltages V1, V2, Vbk, and V3, the relative transmittance of the V-T characteristics gradually decreases once to the lowest value at the voltage Vbk and then increases along a curve. The reason why the relative transmittance gradually decreases in the range of the applied voltage from 0 V to less than Vbk lies in that the phase difference compensation element 50 is disposed to achieve the grayscale level (lowest grayscale level) for displaying the darkest black at the applied voltage Vbk. In addition, an area where the increase rate of the relative transmittance sharply decreases appears around the voltage V4. The voltage V4 is a voltage at which the increase in the relative transmittance begins to saturate.

FIG. 6 demonstrates that an area where the relative transmittance sharply increases appears between the voltage V2 and the voltage V3. FIG. 7 illustrates tangent lines touching the points on the V-T characteristics each corresponding to each of the applied voltages being different stepwise by 0.2 V. Applied voltages Va, Vb, Vc, Vd, Ve, Vf, and Vg indicate voltages increasing stepwise by 0.2 V in this arrangement order. Points Pa, Pb, Pc, Pd, Pe, Pf, and Pg indicate points on the V-T characteristics each corresponding to each of the applied voltages Va, Vb, Vc, Vd, Ve, Vf, and Vg. Tangent lines la, lb, lc, ld, le, lf, and lg indicate the tangent lines each touching each of the points Pa, Pb, Pc, Pd, Pe, Pf, and Pg.

In FIG. 7, the area (X) represents an area where the inclinations of the tangent lines are small and the variation of the inclinations of the tangent lines is small, the area (Y) represents the area where the inclinations of the tangent lines are large and the variation of the inclinations of the tangent lines is small, and the area (Z) located between the area (X) and the area (Y) represents an area where the inclinations of the tangent lines varies from small to large in a mixed manner and the inclinations of the tangent lines is large. The area (Z) corresponds to the area illustrated in FIG. 6 where the relative transmittance sharply increases. In FIG. 7, the points Pa and Pb belong to the area (X), the points Pf and Pg belong to the area (Y), and the points Pc, Pd, and Pe belong to the area (Z).

It can be regarded in the normally black mode that the applied voltages corresponding to the points belonging to the area (Z) are optical threshold voltages that allocate the relative transmittance of the liquid crystal element 12 in the range of approximately from 2 to 10%, and the voltage V4 is an optical saturation voltage that allocates the relative transmittance of the liquid crystal element 12 at approximately 90%.

Such V-T characteristics are obtained by detecting the intensity of the transmitted light while varying the voltages applied to the liquid crystal element 12, irradiating light source light to the liquid crystal panel 100p in a state where the first polarization element 41 and the second polarization element 42 are disposed in crossed Nicols on both sides of the liquid crystal panel 100p.

Countermeasures Against Reverse Tilt Domain

FIG. 8 is an explanatory diagram illustrating a grayscale voltage and the like in the liquid crystal device 100 illustrated in FIG. 1. As illustrated in FIG. 8, Exemplary Embodiment 1 sets a lowest applied voltage corresponding to the grayscale level (lowest grayscale level) for displaying the darkest black as the voltage Vbk belonging to the area (Z) where the relative transmittance sharply increases. Accordingly, as illustrated in FIG. 8, in a light modulation device 1, a grayscale range a corresponds to the voltage range A ranging from the voltage Vbk (the lowest applied voltage Vbk) to the voltage V4. Provided that a highest applied voltage Vwt is defined as the voltage to be applied to achieve the grayscale level (highest grayscale level) for displaying the brightest white, a grayscale range b corresponds to the voltage range B ranging from the voltage V4 to the highest applied voltage Vwt. Because of the above, provided that the voltage at which the relative transmittance of the liquid crystal element 12 becomes 10% is defined as a first threshold voltage Vth1 and the voltage at which the relative transmittance of the liquid crystal element 12 becomes 90% is defined as a second threshold voltage Vth2, the voltage difference between the lowest applied voltage Vbk and the first threshold voltage Vth1 is less than the voltage difference between the highest applied voltage Vwt and the second threshold voltage Vth2.

In Exemplary Embodiment 1, the voltage Vbk is such a voltage that the pretilt angle θp is given to the liquid crystal molecules 85 described with reference to FIG. 3, and is such a voltage that a variation in the transmittance is hardly perceived. For example, the voltage Vbk is in the range of from 0 to 1.5 V from the viewpoint that the variation in the transmittance is hardly perceived in the vicinity of the black level in the normally black mode, while the voltage Vbk is 1.5 V from the viewpoint of being the voltage at which the liquid crystal molecules 85 begin to be tilted.

The optical compensation element 50 performs an optical compensation in such a manner that the intensity of light (transmittance) emitted when the lowest applied voltage Vbk is applied becomes the lowest. This allows, in Exemplary Embodiment 1, the light intensity when 0 V is applied to the liquid crystal element 12 to be higher than the light intensity (transmittance) when the lowest applied voltage Vbk is applied to the liquid crystal element 12.

Principal Effects of Exemplary Embodiment 1

As described above, the liquid crystal device 100 of Exemplary Embodiment 1 prevents an influence of a lateral electric field exerted by an adjacent pixel electrode 9a (the liquid crystal element 12) due to a vertical electric field applied to the liquid crystal molecules 85 illustrated in FIG. 3 even when the lowest applied voltage Vbk is applied. Accordingly, even when the liquid crystal element 12 in the voltage range B is present at a position adjacent to the liquid crystal element 12 to which the lowest applied voltage Vbk is applied, the liquid crystal element 12 to which the lowest applied voltage Vbk (the voltage V1) is applied scarcely generates a reverse tilt domain receiving a lateral electric field from the liquid crystal element 12 in the voltage range B. Thus, according to Exemplary Embodiment 1, unlike the case where the configuration for correcting the applied voltage alone suppresses the influence of the reverse tilt domain, the influence of the reverse tilt domain is suppressed while suppressing the image from being blurred. The optical compensation element 50 performs an optical compensation in such a manner that the light intensity (transmittance) emitted when the lowest applied voltage Vbk is applied becomes the lowest, causing a grayscale display to be properly performed.

### Exemplary Embodiment 2

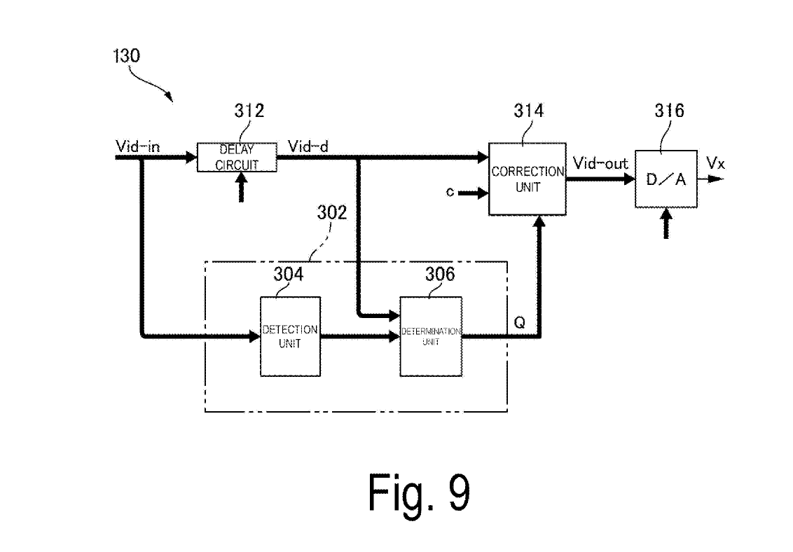

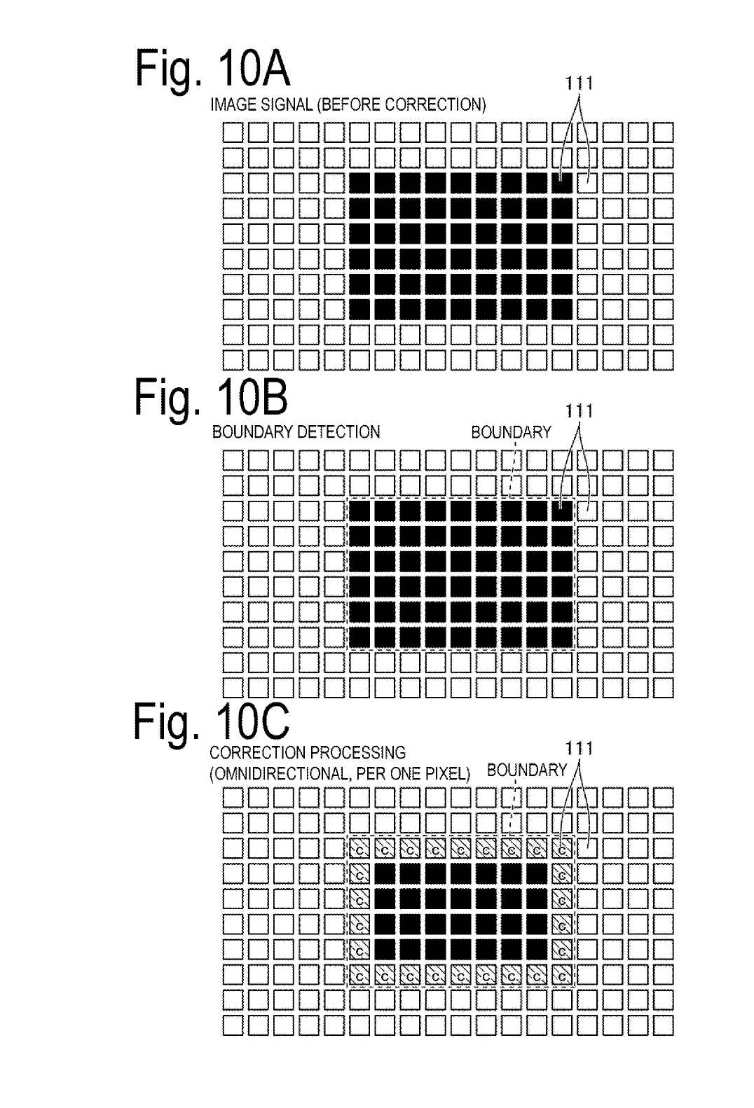

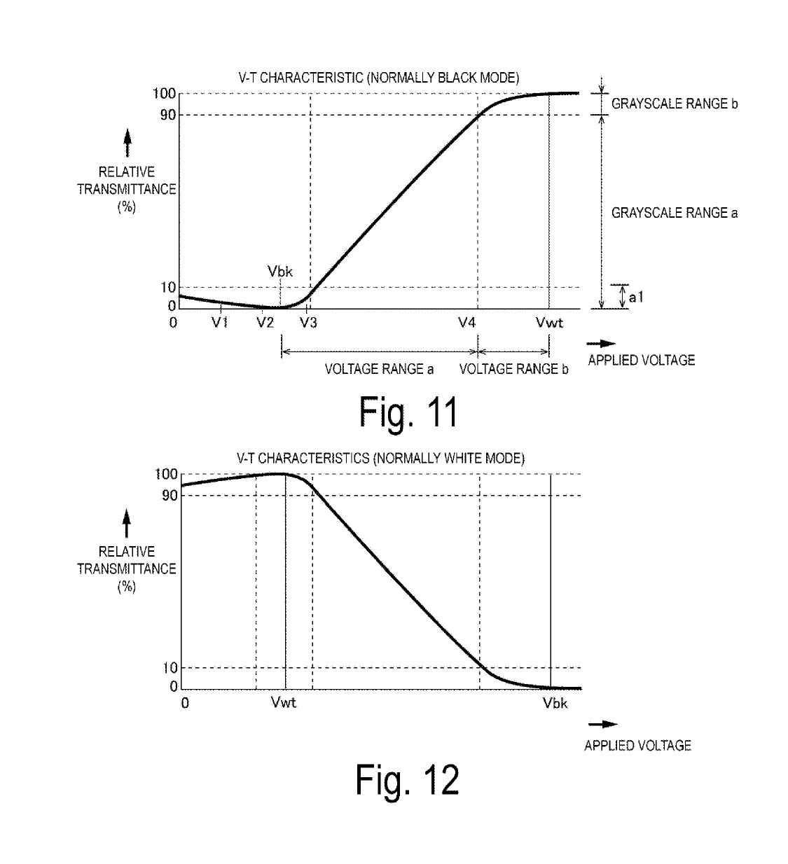

FIG. 9 is an explanatory diagram illustrating the image processing circuit 130 (image processing device) of the light modulation apparatus 1 according to Exemplary Embodiment 2 of the invention. FIGS. 10A to 10C are explanatory diagrams illustrating a correction of an applied voltage performed by the image processing circuit illustrated in FIG. 9. FIG. 11 is an explanatory diagram illustrating a detection of a boundary by the image processing circuit 130 illustrated in FIG. 9. Note that the light modulation device 1 of Exemplary Embodiment 1 includes the configuration of the image processing circuit 130 replaced by the aspect illustrated in FIG. 9 in the light modulation device 1 according to Exemplary Embodiment 1. Accordingly, common components are referenced using like numbers, and no descriptions for such components are provided below.

In Exemplary Embodiment 2, the image processing circuit 130 illustrated in FIG. 9, in a case when a pixel (first pixel) of an applied voltage Vbk is adjacent to a pixel (second pixel) of an applied voltage higher than the voltage V4, corrects the voltage applied to the first pixel or the second pixel to be higher than the voltage Vbk and lower than the voltage V4 such that the potential difference between the applied voltages applied to the first pixel and the second pixel becomes less than a desired potential voltage. In Exemplary Embodiment 2, in a case when the first pixel is adjacent to the second pixel, the applied voltage of the first pixel is corrected to the voltage V3. Accordingly, as will be described below, the signal corresponding to the image illustrated in FIG. 10A is corrected to the signal corresponding to the image illustrated in FIG. 10C.

In Exemplary Embodiment 2, both of the lowest applied voltage Vbk and the voltage V3 are each set to such a voltage that the variation in the transmittance is hardly perceived. For example, the lowest applied voltage Vbk may be set at 1 V and a reference voltage may be set at the voltage V3 (1.5 V).

In achieving such an aspect, the image processing circuit 130 illustrated in FIG. 9 is provided with a boundary detection unit 302, a delay circuit 312, a correction unit 314, and a D/A converter 316. The delay circuit 312, which includes a First In First Out (FIFO) memory, a multi-stage latch circuit, and the like, stores the image signal Vid-in supplied from the host device, reads the signal after a predefined time has elapsed, and then outputs the signal as the image signal Vid-d. Note that the storing and reading in the delay circuit 312 are controlled by the scan control circuit 120 illustrated in FIG. 4.

The boundary detection unit 302 includes a detection unit 304 and a determination unit 306. The detection unit 304 firstly analyzes a frame image represented by the image signal Vid-in to detect the boundary illustrated in FIG. 10B based on the signal illustrated in FIG. 10A. More specifically, the detection unit 304 determines whether there is an adjacent portion where one pixel 11 in the grayscale range al illustrated in FIG. 11 in the grayscale range a and the other pixel 11 in the grayscale range b are adjacent to each other in the vertical or horizontal direction, and secondly, the detection unit 304, when determining that there is the adjacent portion, detects the boundary (edge) that is the adjacent portion. The term boundary used herein absolutely represents a portion where a pixel in the grayscale range al and a bright pixel in the grayscale range b are adjacent to each other. For this reason, for example, a portion where one pixel 11 excluded from the grayscale range al in the grayscale range a and the other pixel 11 in a grayscale range d are adjacent to each other is not regarded as the boundary.

The determination unit 306 determines whether, among pixels 11 represented by the image signal Vid-d having been output in a delayed manner, a dark pixel contiguous to a boundary detected by the detection unit 304 is a pixel of the voltage Vbk. When the determination result is “Yes”, an output signal with a flag Q of “1”, for example, is output, while when the determination result is “No”, the output signal with the flag Q of “0” is output. The detection unit 304 cannot detect, until a certain degree of image signals has been stored, a boundary in the entire vertical or horizontal direction in an image to be displayed. For this reason, the delay circuit 312 is so provided to adjust a supply timing of the image signal Vid-in from the host device. Since the timing of the image signal Vid-in supplied from the host device differs from the timing of the image signal Vid-d supplied from the delay circuit 312, their horizontal scanning periods and the like do not coincide with each other in a strict sense. However, the following description will be given without specific discrimination. The storage of the image signal Vid-in for detecting the supply in the detection unit 304 is controlled by the scan control circuit 120.

The correction unit 314, when the flag Q supplied from the determination unit 306 is “1”, replaces the image signal Vid-d by an image signal of a corrected grayscale level and outputs the image signal as the image signal Vid-out. In other words, when the voltage applied to the liquid crystal element 12 is the voltage Vbk, the correction unit 314 corrects the voltage applied to the liquid crystal element 12 to the voltage V3 (reference voltage). The D/A converter 316 converts the image signal Vid-out as digital data into an analog data signal Vx.

According to the image processing circuit 130 thus configured, as illustrated for example by the image signal before correction in FIG. 10A, when the frame image represented by the image signal Vid-in is partially an image displaying a window area of black pixels with white pixels as the background, the image signals of the dark pixels are corrected as illustrated in FIG. 10C. Accordingly, the image illustrated in FIG. 10C becomes an image corrected by the image processing circuit 130.

For this reason, when the window area of the black pixels moves by one pixel in any direction, there is to be no portion where a black pixel adjacent to a white pixel is directly changed to a white pixel. For example, even when the window area of the black pixels moves leftward by one pixel, a black pixel adjacent to a white pixel at the image signal Vid-in is changed to the grayscale level of the voltage V3 and is then changed to a white pixel. This prevents the area where the reverse tilt domain is readily generated from becoming contiguous with the movement of the black pixel. Furthermore, since, among the images defined by the image signal Vid-in, the grayscale level of the dark pix contiguous to the boundary is locally replaced, the correction of the display image due to the replacement is scarcely perceived by the user.

Note that the number of pixels at which the applied voltage is corrected may be two or more. For example, when a level darker than the grayscale level c is designated to each of a dark pixel contiguous to the boundary and the other dark pixel adjacent to the dark pixel on the opposite side to the boundary, the two pixels may be replaced by image signals of the grayscale level c. The candidate number of pixels to be replaced may be “3” or more, and is not limited to “2”. In addition, a correction may be performed on only one of the boundaries in the horizontal direction and in the vertical direction.

### Exemplary Embodiment 3

FIG. 12 is an explanatory diagram illustrating a grayscale voltage and the like of the liquid crystal device 100 according to Exemplary Embodiment 3 of the invention. Although Exemplary Embodiments 1 and 2 employ a normally black mode, the invention may also be applied when a normally white mode is employed. In this case, the grayscale voltage and the like are as illustrated in FIG. 12, where only black and white are interchanged with reference to Exemplary Embodiments 1 and 2. Thus, the corresponding voltages and the like are referenced using like numbers in FIG. 8 and FIG. 11, and no descriptions for such elements are provided below. That is, the optical compensation element is disposed such that, in the light intensity-voltage characteristic, the intensity of the light emitted from the liquid crystal element is maximized with an applied voltage Vwt corresponding to a point belonging to an area having a large change in inclination of a tangent line disposed between two areas exhibiting a small change in inclination of a tangent line touching each of the points on the light intensity-voltage characteristic corresponding to each of the applied voltages at every predefined voltage interval.

### Other Exemplary Embodiments

Although in the above exemplary embodiments, the liquid crystal panel 100p is of a transmissive-type, the invention may also be applied to the case where the liquid crystal panel 100p is of a reflective-type.

Installation Example for Electronic Apparatus

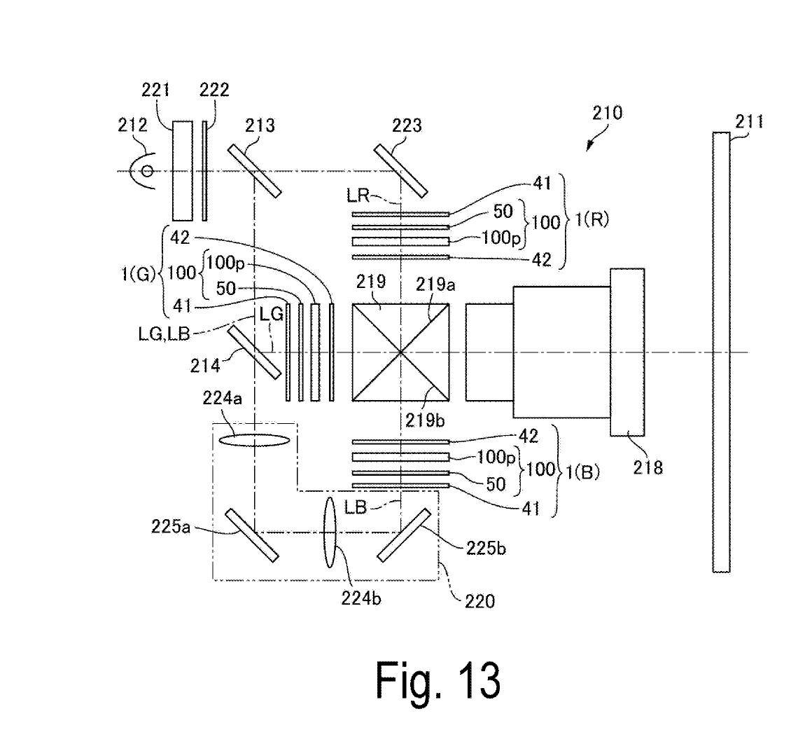

FIG. 13 is a schematic configuration diagram illustrating a projection-type display apparatus (electronic apparatus) employing the liquid crystal device 100 to which the invention is applied. Note that in the descriptions below, although a plurality of optical modulators 1 (R), (G), and (B) are used to which light in mutually different wavelength regions are supplied, the liquid crystal device 100 to which the invention is applied is used in any of the optical modulators 1 (R), (G), and (B).

A projection-type display device 210 depicted in FIG. 13 serves as a projection-type projector configured to project an image on a screen 211 provided anteriorly. The projection-type display device 210 includes a light source 212, dichroic mirrors 213 and 214, optical modulators 1 (R), (G), and (B), a projection optical system 218, a cross dichroic prism 219, and a relay system 220. Each of the optical modulators 1 (R), (G), and (B), which is the optical modulator 1 described with reference to FIG. 2 and the like, includes, along the traveling direction of the light L, the first polarization element 41, the liquid crystal device 100 (the optical compensation element 50 and the liquid crystal panel 100p), and the second polarization element 42.

The light source 212 is configured by an extra-high-pressure mercury lamp for supplying light including red light, green light, and blue light, for example. The dichroic mirror 213 is configured to be transmissive of the red light LR from the light source 212 and reflective of the green light LG and the blue light LB. The dichroic mirror 214 is configured to be transmissive of the blue light LB and reflective of the green light LG among the green light LG and the blue light LB reflected by the dichroic mirror 213. As such, the dichroic mirrors 213 and 214 constitute a color separation optical system configured to separate light emitted from the light source 212 into red light LR, green light LG, and blue light LB. An integrator 221 and a polarization conversion element 222 are sequentially arranged, between the dichroic mirror 213 and the light source 212, from the light source 212. The integrator 221 equalizes the illuminance distribution of the light irradiated from the light source 212. The polarization conversion element 222 converts the light from the light source 212 into polarized light having a specific vibration direction such as s-polarized light.

The optical modulator 1 (R) modulates the red light LR transmitted through the dichroic mirror 213 and reflected by a reflection mirror 223 in accordance with image signals. The red light LR incident on the optical modulator (R) and then transmitted through the first polarization element 41 is converted into, for example, s-polarized light. The liquid crystal panel 100p converts, by modulation in accordance with image signals, the incident s-polarized light into p-polarized light (circularly polarized light or elliptically polarized light in the case of halftone). Moreover, the second polarization element 42 blocks s-polarized light and transmits p-polarized light. Accordingly, the optical modulator 1 (R) modulates the red light LR in accordance with image signals and then emits the modulated red light LR toward the cross dichroic prism 219.

The optical modulator 1 (G) modulates, in accordance with image signals, the green light LG reflected by the dichroic mirror 213 and then reflected by the dichroic mirror 214. The optical modulator 1 (G) emits the modulated green light LG toward the cross dichroic prism 219.

The optical modulator 1 (B) modulates, in accordance with image signals, the blue light LB reflected by the dichroic mirror 213, transmitted through the dichroic mirror 214, and then passed through the relay system 220. The optical modulator 1 (B) emits the modulated blue light LB toward the cross dichroic prism 219.

The relay system 220 includes relay lenses 224a and 224b and reflection mirrors 225a and 225b. The relay lenses 224a and 224b are provided to prevent the loss of light due to the long optical path of the blue light LB. The relay lens 224a is disposed between the dichroic mirror 214 and the reflection mirror 225a.

The relay lens 224b is disposed between the reflection mirrors 225a and 225b. The reflection mirror 225a is disposed to reflect, toward the relay lens 224b, the blue light LB transmitted through the dichroic mirror 214 and then emitted from the relay lens 224a. The reflection mirror 225b is disposed to reflect the blue light LB emitted from the relay lens 224b toward the optical modulator 1 (B).

The cross dichroic prism 219 serves as a color synthesizing optical system in which two dichroic films 219a and 219b are orthogonally arranged in an X shape. The dichroic film 219a reflects the blue light LB and transmits the green light LG. The dichroic film 219b reflects the red light LR and transmits the green light LG.

Accordingly, the cross dichroic prism 219 is configured to synthesize the red light LR, the green light LG, and the blue light LB modulated by the optical modulators 1 (R), (G), and (B) respectively and to emit the synthesized light toward the projection optical system 218. The projection optical system 218, which includes a projection lens (not illustrated), is configured to project the light synthesized by the cross dichroic prism 219 onto the screen 211.

Note that such a configuration may also be employed that a λ/2 phase difference compensation element is provided for the optical modulators 1 (R) and (B) for red and blue light, in which the light incident on the cross dichroic prism 219 from the optical modulators 1 (R) and (B) is converted into s-polarized light, and the optical modulator 1 (G) is configured to avoid including a λ/2 phase difference compensation element, in which the light incident on the cross dichroic prism 219 from the optical modulator 1 (G) is converted into p-polarized light.

A color synthesizing optical system can be configured, optimized in view of the reflection characteristics of the dichroic films 219a and 219b, by modulating the light incident on the cross dichroic prism 219 into different types of polarized light. The red light LR and the blue light LB reflected by the dichroic films 219a and 219b as described above may be converted into s-polarized light, and the green light LG that transmits through the dichroic films 219a and 219b may be converted into p-polarized light, taking advantage of the dichroic films 219a and 219b normally having excellent reflection characteristics for s-polarized light.

Other Projection-Type Display Apparatuses

A projection-type display apparatus may be configured to use, as a light source unit, an LED light source, a laser light source, or the like configured to emit light in various colors to supply light in various colors emitted from the light source unit to another liquid crystal apparatus.

The liquid crystal device to which the invention is applied may be used for a variety of electronic apparatuses such as a projection-type head-up display (HUD) and a direct viewing-type head-mounted display (HMD) in addition to the above electronic apparatuses.

The entire disclosure of Japanese Patent Application No. 2018-004011, filed Jan. 15, 2018 is expressly incorporated by reference herein.

What is claimed is:

1. A liquid crystal device comprising:
a liquid crystal element;
an image processing circuit configured to output an applied voltage to be applied to the liquid crystal element; and
a phase difference compensation element disposed in the liquid crystal element, wherein
provided that a light intensity-voltage characteristic is defined by a relationship between the applied voltage and an intensity of light emitted from the liquid crystal element,
the phase difference compensation element is configured to minimize or maximize the intensity of the light emitted from the liquid crystal element with an applied voltage corresponding to a point belonging to an area having a large change in inclination of a tangent line located between two areas exhibiting a small change in inclination of a tangent line touching each of points on the light intensity-voltage characteristic.

2. The liquid crystal device according to claim 1, wherein
the liquid crystal element is set in a normally black mode, and a point belonging to an area having a large inclination of the tangent line corresponds to a lowest grayscale level among voltages applied to the liquid crystal element.

3. The liquid crystal device according to claim 2, wherein
an applied voltage corresponding to the lowest grayscale level is higher than 0 V and a light intensity when the applied voltage is set at 0 V is higher than a light intensity when the applied voltage is set at the applied voltage corresponding to the lowest grayscale level.

4. The liquid crystal device according to claim 2, wherein
provided that a first threshold voltage is defined as a voltage at which a relative transmittance of the liquid crystal element becomes 10%, a second threshold voltage is defined as a voltage at which a relative transmittance of the liquid crystal element becomes 90%, and a highest applied voltage is defined as the applied voltage at which a highest grayscale level is achieved, and
a voltage difference between a lowest applied voltage and the first threshold voltage is less than a voltage difference between the highest applied voltage and the second threshold voltage.

5. The liquid crystal device according to claim 1, wherein
the liquid crystal element includes a liquid crystal layer between a pixel electrode formed on a first substrate and a common electrode formed on a second substrate,
the first substrate is provided with a first alignment film to cover the pixel electrode and the second substrate is provided with a second alignment film to cover the common electrode,
the first alignment film and the second alignment film each include a columnar structure layer in which columnar bodies are obliquely formed with respect to both the pixel electrode and the common electrode, and
liquid crystal molecules used in the liquid crystal element have negative dielectric anisotropy, the liquid crystal molecules being aligned to have a pretilt inclined with respect to both the first substrate and the second substrate.

6. The liquid crystal device according to claim 5, wherein
a lowest applied voltage corresponding to the lowest grayscale level is a voltage that causes the liquid crystal molecules to be aligned at an angle corresponding to a pretilt angle.

7. The liquid crystal device according to claim 1, wherein
the image processing circuit is configured to correct an applied voltage applied to either one of the liquid crystal element and an adjacent liquid crystal element adjacent to the liquid crystal element such that a potential difference of applied voltages applied to the liquid crystal element and to the adjacent liquid crystal element adjacent to the liquid crystal element falls within a predefined range.

8. An electronic apparatus comprising the liquid crystal device according to claim 1.
